(19) United States
(12) Patent Application Publication
(10) Pub. No.: US 2026/0154549 A1
(43) Pub. Date: Jun. 4, 2026

(54) MACHINE LEARNING APPARATUS, MACHINE LEARNING METHOD, AND COMPUTER READABLE NON-TRANSITORY RECORDING MEDIUM STORING MACHINE LEARNING PROGRAM

(71) Applicant: JVCKENWOOD Corporation, Yokohama-shi (JP)

(72) Inventor: Shingo KIDA, Yokohama-shi (JP)

(21) Appl. No.: 19/460,402

(22) Filed: Jan. 27, 2026

Related U.S. Application Data
(63) Continuation of application No. PCT/JP2024/017653, filed on May 13, 2024.

(30) Foreign Application Priority Data
Jul. 27, 2023 (JP) 2023-122295

(51) Int. Cl. G06N 3/08; G06V 10/764

(52) U.S. Cl. CPC G06N 3/08; G06V 10/764

(57) ABSTRACT

A linguistic feature amount output part receives a text describing a base class image and outputs a linguistic feature amount. An image feature amount output part receives the base class image and outputs an image feature amount. A base class image selection part receives the linguistic feature amount, the image feature amount, and the base class image and selects a base class image corresponding to the image feature amount having a distance equal to or smaller than a predetermined threshold value from the linguistic feature amount. A neural network lower layer part receives the base class image selected by the base class image selection part and a novel class image and outputs a value based the base class image and a value based on the novel class image. A base class classification output part outputs a base class classification based on the base class image and the novel class image. A novel class classification output part outputs a novel class classification based on the novel class image.

### CROSS REFERENCE TO RELATED APPLICATION

This application is a continuation of application No. PCT/JP 2024/017653, filed on May 13, 2024, and claims the benefit of priority from the prior Japanese Patent Application No. 2023-122295, filed on Jul. 27, 2023, the entire content of which is incorporated herein by reference.

### BACKGROUND

### 1. Technical Field

The present disclosure relates to a machine learning technology.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-learn CNN parameters in response to the entirety of the dataset.

A more efficient and practical method available is incremental learning or continual learning in which new tasks are learned, reusing the knowledge already acquired. In particular, continual learning in a classification task is a method that allows migration from a state in which classification into base classes (classes learned in the past) is enabled to a state in which new classes (novel classes) can be learned for classification.

Meanwhile, there is a phenomenon in deep learning called catastrophic forgetting in which the knowledge acquired in the past is considerably lost, and the ability for tasks is considerably reduced. This presents a problem in continual learning in particular. In continual learning in a classification task, the biggest challenge is to suppress catastrophic forgetting and maintain the performance for base class classification while at the same time acquiring the performance for novel class classification.

On the other hand, new tasks often have only a limited number of sample data items available. Therefore, few-shot learning has been proposed as a method for efficient learning from a small number of training data items. Normally, several thousand samples are necessary for learning. In few-shot learning, however, a task is learned by using a small number of samples (e.g., several samples).

Further, class incremental learning (CIL) has been proposed to additionally train a model already trained on a basic (base) class, thereby enabling classification into a new class (novel class). In CIL, tasks are continually added to a model trained for classification, and novel tasks require classification performance for novel classes and past classes. Normally, training data for novel tasks is big data.

A method called few-shot class incremental learning (FSCIL) has been proposed, which combines continual learning, in which a novel class is learned without catastrophic forgetting of the result of learning the basic (base) class, with few-shot learning, in which a novel class with fewer samples as compared to the base class is learned (Non-Patent Literature 1). In incremental few-shot learning, the base class can be learned from a large-scale dataset, while the novel class can be learned from a small number of sample data items. FSCIL is an incremental learning scenario for classification similar to CIL but significantly differs in that the number of samples in the training data of the novel class is small (small data).

SaB (Split-and-Bridge) has been proposed (see, for example, Non-Patent Literature 2) as one method for continual learning in classification learning. SaB realizes high adaptability to novel classes and suppression of forgetting of past knowledge, while restraining the growth of the network scale. The SaB consists of a split phase in which the network is split into partitions for past knowledge and new knowledge in an incremental task to learn the knowledge, and of a bridge phase in which the network portions are subsequently recombined and trained. In the split phase, the lower layer of the network is shared between past knowledge and new knowledge, and the upper layer of the network is split and allocated to past knowledge and new knowledge, respectively to enable separate acquisition of past knowledge and new knowledge in the local space (learning is performed concurrently). In the bridge phase, the integrated knowledge of past knowledge (base class) and novel knowledge (novel class) are learned by combining the split network partitions.

[Non-patent literature 1] Zhang, C., Song, N., Lin, G., Zheng, Y., Pan, P., & Xu, Y. (2021). Few-shot incremental learning with continually evolved classifiers. In Proceedings of the IEEE/CVF Conference on Computer Vision and Pattern Recognition (pp. 12455-12464).

[Non-patent literature 2] Jong-Yeong Kim, Dong-Wan Choi. (2021). “Split-and-Bridge: Adaptable Class Incremental Learning within a Single Neural Network.” In Proceedings of the AAAI Conference on Artificial Intelligence (pp. 8137-8145).

[Non-patent literature 3] Nishida, K., Nishida, K., & Nishioka, S. (2022). Improving Few-Shot Image Classification Using Machine-and User-Generated Natural Language Descriptions. arXiv preprint arXiv: 2207.03133.

In SaB, the novel class images and some of the base class images as rehearsal data are used when an incremental task is learned. In SaB, some of the base class images are used when an incremental task is learned, but those images are randomly selected. There has been an issue in that, when images are randomly selected, features useful to represent the base class could not be fully reflected in incremental learning.

### SUMMARY

A machine learning apparatus according to an embodiment includes: a linguistic feature amount output part that receives a text describing a base class image and outputs a linguistic feature amount; an image feature amount output part that receives the base class image and outputs an image feature amount; and a base class image selection part that receives the linguistic feature amount, the image feature amount, and the base class image and selects a base class image corresponding to the image feature amount having a distance equal to or smaller than a predetermined threshold value from the linguistic feature amount. The apparatus further includes a pre-trained neural network. The neural network includes: a neural network lower layer part that receives the base class image selected by the base class image selection part and a novel class image and outputs a value; and a neural network upper layer part that is provided on an output side with respect to the neural network lower layer part and that includes i) a base class classification output part that receives an output value of the neural network lower layer part based on the base class image and the novel class image and that outputs a base class classification which is a classification based on the base class image and the novel class image and ii) a novel class classification output part that receives an output value of the neural network lower layer part based on the novel class image and that outputs a novel class classification which is a classification based on the novel class image. The apparatus further includes: a loss calculation part that calculates a loss in the base class classification and a loss in the novel class classification based on the base class classification and the novel class classification; and an updating part that updates a weight of the neural network lower layer part, a weight of the base class classification output part, and a weight of the novel class classification output part based on a sum of the loss in the base class classification and the loss in the novel class classification.

Another embodiment also relates to a machine learning apparatus. The apparatus includes: a linguistic feature amount output part that receives a text describing a base class image and outputs a linguistic feature amount; an image feature amount output part that receives the base class image and outputs an image feature amount; and a base class image selection part that receives the linguistic feature amount, the image feature amount, and the base class image and selects a base class image corresponding to the image feature amount having a distance equal to or smaller than a predetermined threshold value from the linguistic feature amount. The apparatus further includes a pre-trained neural network. The neural network includes: a neural network lower layer part that receives the base class image selected by the base class image selection part and a novel class image and outputs a value; and a neural network upper layer part that is provided on an output side with respect to the neural network lower layer part and that receives an output value of the neural network lower layer part based on the base class image and the novel class image and that outputs a base class classification or a novel class classification which is a classification based on the base class image and the novel class image. The apparatus further includes: a loss calculation part that calculates a loss in the base class classification and a loss in the novel class classification based on the base class classification and the novel class classification; and an updating part that updates a weight of the neural network lower layer part and a weight of the neural network upper layer part based on a sum of the loss in the base class classification and the loss in the novel class classification.

Still another embodiment relates to a machine learning method. The method includes: receiving a text describing a base class image and outputting a linguistic feature amount; receiving the base class image and outputting an image feature amount; receiving the linguistic feature amount, the image feature amount, and the base class image and selecting a base class image corresponding to the image feature amount having a distance equal to or smaller than a predetermined threshold value from the linguistic feature amount; receiving, in a neural network lower layer part of a pre-trained neural network, i) the base class image selected by the selecting of a base class image and ii) a novel class image and outputting a value; in a neural network upper layer part that is provided on an output side with respect to the neural network lower layer part, i) by a base class classification output part, receiving an output value of the neural network lower layer part based on the base class image and the novel class image and outputting a base class classification which is a classification based on the base class image and the novel class image and ii) by a novel class classification output part, receiving an output value of the neural network lower layer part based on the novel class image and outputting a novel class classification which is a classification based on the novel class image; calculating a loss in the base class classification and a loss in the novel class classification based on the base class classification and the novel class classification; and updating a weight of the neural network lower layer part, a weight of the base class classification output part, and a weight of the novel class classification output part based on a sum of the loss in the base class classification and the loss in the novel class classification.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWINGS

The disclosure will be described with reference to the following drawings.

FIG. 1 shows a configuration of a pre-trained module;

FIG. 2 shows a configuration of the NN used in the split phase of SaB;

FIG. 3 is a functional block diagram for explaining a configuration of a related-art machine learning apparatus used in the split phase of SaB;

FIG. 4 is a functional block diagram for explaining a configuration of the related-art machine learning apparatus used in the bridge phase of SaB;

FIG. 5 illustrates a method of selecting the base class image in the embodiment;

FIG. 6 shows a functional configuration of the machine learning apparatus of the embodiment in the split phase; and

FIG. 7 shows a functional configuration of the machine learning apparatus of the embodiment in the bridge phase.

### DETAILED DESCRIPTION

The invention will now be described by reference to the preferred embodiments. This does not intend to limit the scope of the present invention, but to exemplify the invention.

First, an overview of SaB, which is a related art, will be described. In SaB, a common neural network (hereinafter, sometimes referred to as “NN”) model is used to perform classification.

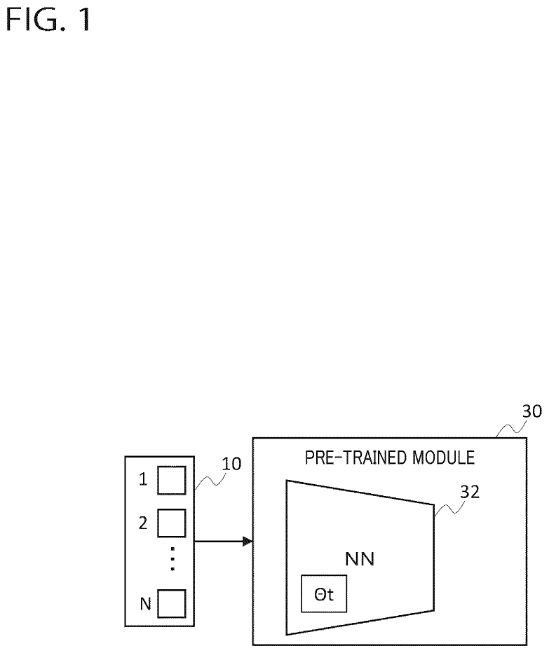

First, in a basic task of incremental learning, the NN is pre-trained for base class classification by using big data. FIG. 1 shows a configuration of a pre-trained module 30. The pre-trained module 30 includes an NN 32 and a base class classification weight Θt of the NN 32.

A base class dataset 10 includes N samples. One example of a sample is an image, but the sample is not limited thereto. The NN 32 is a neural network pre-trained on the base class dataset 10. The weight of the NN 32 is Θt.

In an incremental task in SaB incremental learning, learning is performed in the split phase based on a trained weight, and the trained weight is further trained in the bridge phase.

The split phase aims to learn i) past knowledge (base class) in a local space for classification into a past class in a past task with respect to the current incremental task and ii) new knowledge (novel class) in a local space for classification only into a novel class in the current incremental task. In the split phase, therefore, the upper layer part in the NN 32 is split into two partitions including a portion that uses a weight θo for learning the base class and a portion using a weight θn for learning the novel class. In the lower layer part of the NN 32, a weight θs is commonly used for the base class and the novel class. In this case, the base class loss is calculated by using <θs, θo>. The novel class loss is calculated by using <θs, θn>. Learning is performed based on a loss derived from summing the losses.

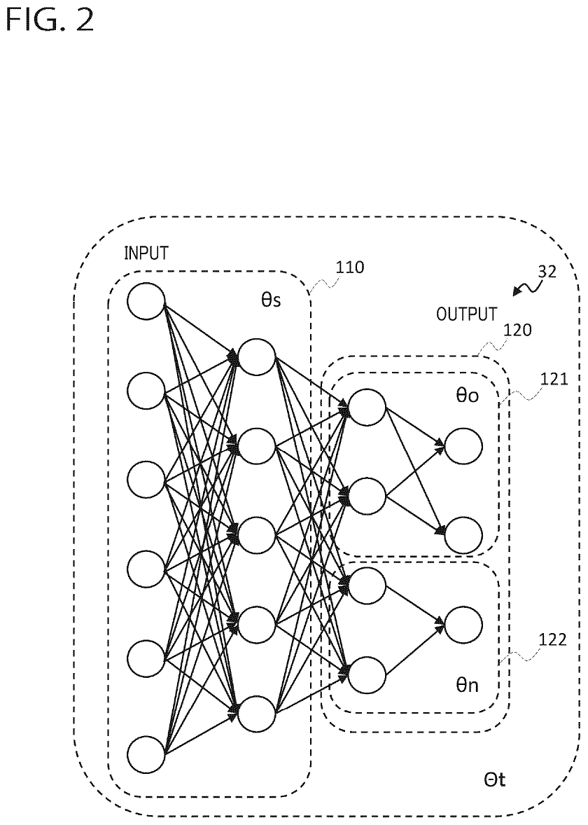

FIG. 2 shows a configuration of the NN 32 used in the split phase. In SaB, as shown in FIG. 2, an NN lower layer part 110 comprised of one or more layers on the input side and an NN upper layer part 120 comprised of one or more layers on the output side with respect to the NN lower layer part 110 are set in the NN 32. The weight of the NN 32 as a whole is Θt. The weight θs is used in the NN lower layer part 110. In the NN upper layer part 120, the base class classification weight θo, and the novel class classification weight θn are used in the two partitions. The NN upper layer part 120 includes a base class classification output part 121 that uses base class classification weight θo and a novel class classification output part 122 that uses the novel class classification weight θn. Prior to the split phase, a preprocess for sparcification of the weights to be split in the split phase is performed. The nodes in the base class classification output part 121 and the nodes in the novel class classification output part 122 are not connected, and so there is no propagation between these nodes. For example, the method described in Non-Patent Literature 2 is used as the method for setting the NN lower layer part 110 with the weight θs, the base class classification output part 121 with the weight θo, and the novel class classification output part 122 with the weight θn based on the pre-trained NN 32 with the weight Θt.

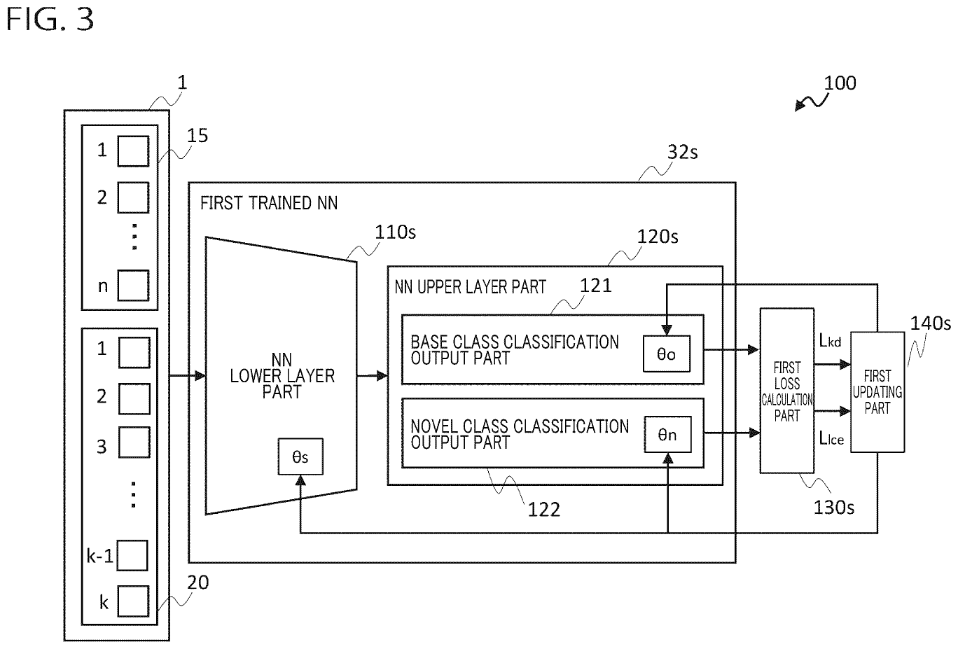

FIG. 3 is a functional block diagram for explaining a configuration of a related-art machine learning apparatus 100 used in the split phase of SaB. The machine learning apparatus 100 of FIG. 3 has not learned an incremental task yet. The dataset 1 includes rehearsal data 15 of a base class and a dataset 20 of a novel class. The rehearsal data 15 of a base class represents a part of the base class dataset 10 and includes n samples (N>n). The dataset 20 of a novel class includes k samples. One example of a sample is an image, but the sample is not limited thereto.

The related-art machine learning apparatus 100 includes a first trained NN 32s pre-trained on the base class, a first loss calculation part 130s, and a first updating part 140s. The first trained NN 32s includes an NN lower layer part 110s and an NN upper layer part 120s.

The NN lower layer part 110s receives data of a base class and the data of a novel class and outputs values by using the weight θs in response to both the base class data and the novel class data.

In SaB, as described above, the NN upper layer part 120s includes the base class classification output part 121 that uses the weight θo and the novel class classification output part 122 that uses the weight θn. The base class classification output part 121 receives the output value of the NN lower layer part 110s based on the base class data and the novel class data and outputs a classification (hereinafter referred to as a base class classification) based on the base class data and the novel class data by using the weight θo. The novel class classification output part 122 receives the output value of the NN lower layer part 110s based on the novel class data and outputs a classification (hereinafter referred to as a novel class classification) based on the novel class data by using the weight θn.

The first loss calculation part 130s receives the base class classification and the novel class classification from the NN upper layer part 120s and calculates a knowledge distillation loss Lkd based on the base class classification and calculates a cross-entropy loss Llce based on the novel class classification.

The first updating part 140s receives the knowledge distillation loss Lkd and the cross-entropy loss Llce from the first loss calculation part 130s and updates the weights θs, θo and θn based on the loss derived from summing the knowledge distillation loss Lkd and the cross-entropy loss Llce. In updating the weights θs, θo and θn, the weights θs, θo and θn of the NN lower layer part 110s are respectively updated so as to reduce the sum of the knowledge distillation loss Lkd and the cross-entropy loss Llce. For example, the method described in Non-Patent Literature 2 is used as the method for calculating the loss in classification in the first loss calculation part 130s and the updating method in the first updating part 140s.

A series of processes of the split phase described above are repeatedly executed according to the number of one or more epochs defined as hyperparameters.

The bridge phase aims to learn integrated knowledge for classification into all past and novel classes in the current incremental task and learns integrated knowledge with the weights θs, θo, and θn updated in the split phase. In the bridge phase, the nodes in the base class classification output part 121 and the novel class classification output part 122 of FIG. 2 that were not connected are connected, and learning is performed in a normal, full-connected NN state.

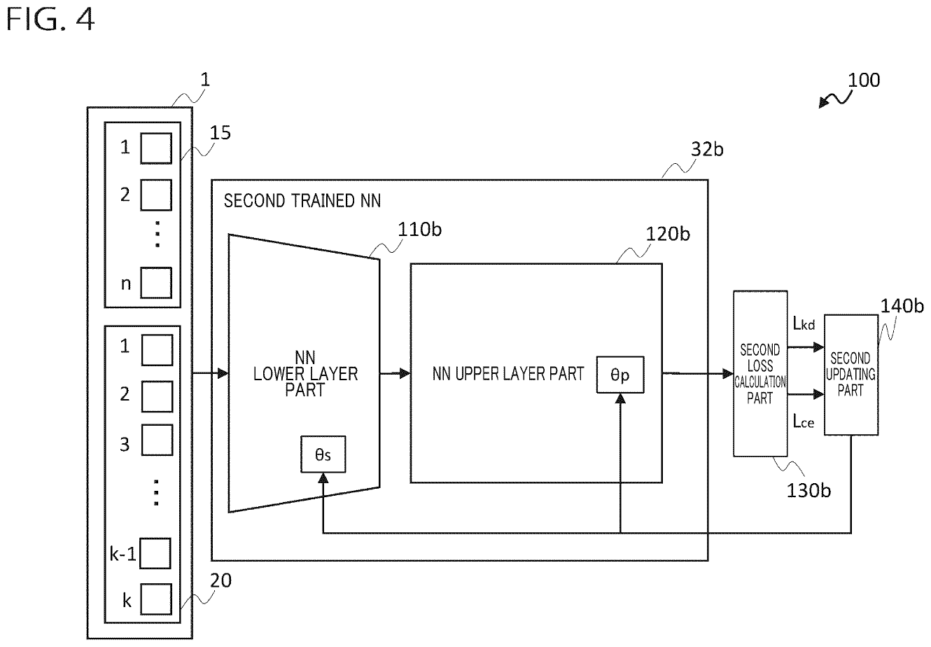

FIG. 4 is a functional block diagram for explaining a configuration of the related-art machine learning apparatus 100 used in the bridge phase of SaB. A duplicate description of the configuration of the related-art machine learning apparatus 100 used in the split phase of SaB will be omitted, and only the differences will be highlighted.

The related-art machine learning apparatus 100 includes a second trained NN 32b trained in the split phase, a second loss calculation part 130b, and a second updating part 140b. In the bridge phase, the second trained NN32b uses, as initial values, the weights of the classifiers trained in the first trained NN32s, i.e., the weights θs, θo, and θn updated by the first updating part 140s in the split phase. The second trained NN 32b includes an NN lower layer part 110b that uses the weight θs updated in the split phase, and an NN upper layer part 120b that uses a weight θp derived from integrating the weights θo and θn updated in the split phase.

The second trained NN 32b receives the base class data and the novel class data and outputs a classification (hereinafter referred to as an integrated classification) based on the base class data and the novel class data by using the weights θs and θp. The data input to the second trained NN 32b is the same data as used in the split phase. The second trained NN 32b has the same number of layers and nodes as the first trained NN 32s and corresponds to a configuration in which the nodes of adjacent layers are all connected in the base class classification output part 121 and the novel class classification output part 122 of the first trained NN 32s. The NN lower layer part 110b of the second trained NN 32b has the same number of layers and nodes as the NN lower layer part 110s of the first trained NN 32s. The NN upper layer part 120b of the second trained NN 32b has the same number of layers and nodes as the NN upper layer part 120s of the first trained NN 32s and corresponds to a configuration in which the nodes of adjacent layers are all connected in the base class classification output part 121 and the novel class classification output part 122 of the first trained NN 32s. Therefore, the NN upper layer part 120b of the second trained NN 32b corresponds to a configuration in which the base class classification output part 121 and the novel class classification output part 122 of the NN upper layer part 120s of the first trained NN 32s are integrated.

The second loss calculation part 130b receives the integrated classification from the second trained NN 32b and calculates the knowledge distillation loss Lkd and the cross-entropy loss Lce respectively based on the integrated classification and calculates the sum of the knowledge distillation loss Lkd and the cross-entropy loss Lce as the loss in classification. The sum of the knowledge distillation loss Lkd and the cross-entropy loss Lce in the bridge phase is an example of the loss in classification.

The second updating part 140b updates the weights θs and θp of the second trained NN 32b based on the loss in classification. For example, the second updating part 140b receives the loss in classification from the second loss calculation part 130b and updates the weights θs and θp based on the loss in classification. The weights θs and θp of the second trained NN 32b are updated respectively so as to reduce the loss in classification.

A series of processes of the bridge phase are repeatedly executed according to the number of one or more epochs defined as hyperparameters.

The related-art SaB assumes CIL, and big data, i.e., a large number of samples, are used for the novel class in the incremental task.

A description will now be given of an embodiment of the present disclosure. The related art uses some of the base class images as rehearsal data during incremental training, but the images are randomly selected. In the embodiment, a linguistic feature, including a visual notion of the base class, is generated, and an image having a feature in the vicinity of the linguistic feature is selected as an image (rehearsal data) for the base class.

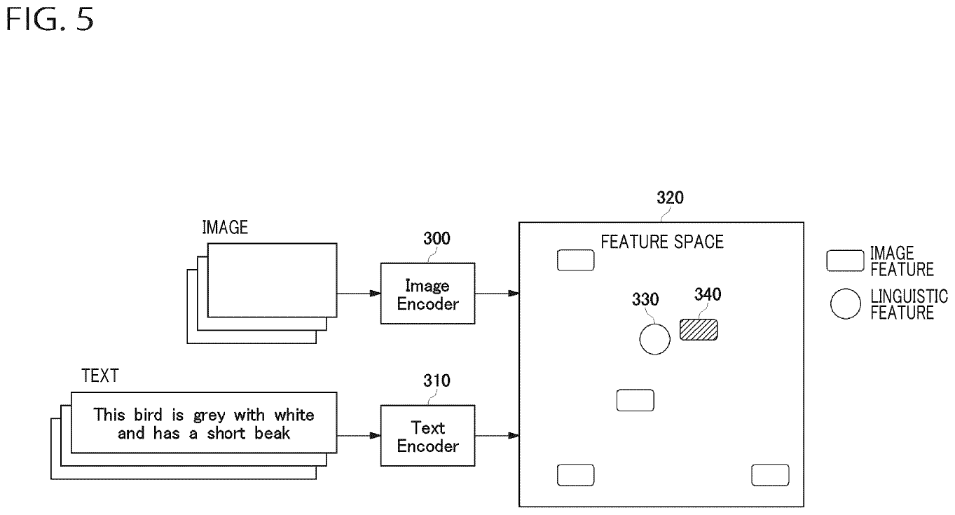

FIG. 5 illustrates a method of selecting the base class image in the embodiment.

The image encoder 300 and the text encoder 310 of FIG. 5 use, as described in Non-patent literature by way of example, a trained model sufficiently trained on big data that pairs an image and a text describing the image. Multiple base class images are processed by the image encoder 300 to acquire an image feature amount of each image. In addition, the text describing the base class image is processed by the text encoder 310 to acquire a linguistic feature amount. A compatible format is used so that the image feature amount and the linguistic feature amount acquired can be projected onto the same feature space 320.

The text describing the base class image describes the visual notion of the base class image. For example, the text may be a sentence like “this bird has a gray color mixed with white and a short beak.

In the feature space 320, an image having an image feature amount 340 in the vicinity of a linguistic feature amount 330 that includes a visual notion of a base class is selected and used as the base class image (rehearsal data) during incremental learning.

According to the embodiment, an image having a feature amount representing a visual notion of a base class can be used during incremental learning, enabling effective base class earning.

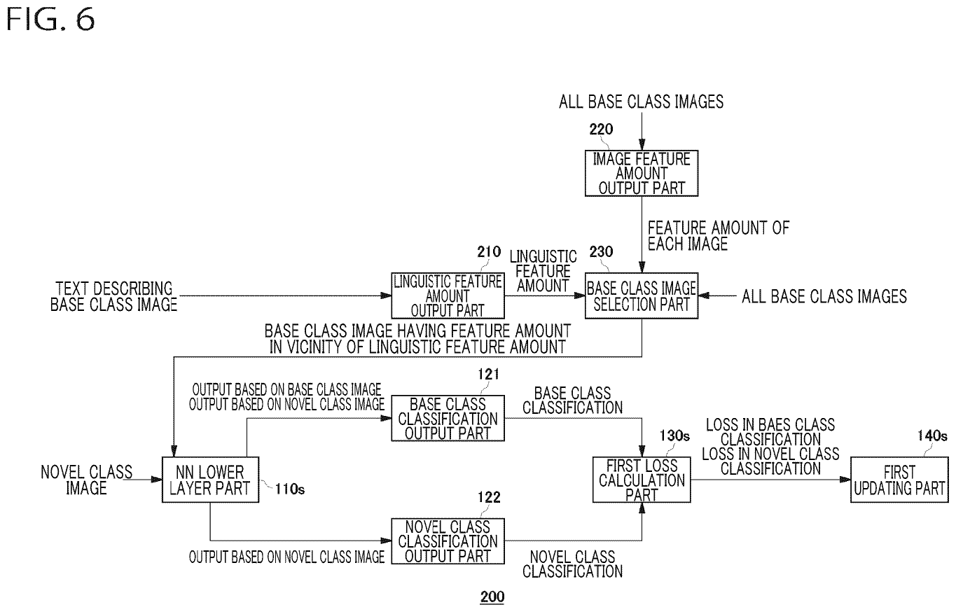

FIG. 6 shows a functional configuration of the machine learning apparatus 200 of the embodiment in the split phase. The machine learning apparatus 200 of the embodiment includes an NN lower layer part 110s, a base class classification output part 121, a novel class classification output part 122, a first loss calculation part 130s, a first updating part 140s, a linguistic feature amount output part 210, an image feature amount output part 220, and a base class image selection part 230.

The NN lower layer part 110s, the base class classification output part 121, the novel class classification output part 122, the first loss calculation part 130s, and the first updating part 140s of the machine learning apparatus 200 of FIG. 6 of the embodiment correspond to the NN lower layer part 110s, the base class classification output part 121, the novel class classification output part 122, the first loss calculation part 130s, and the first updating part 140s of the related-art machine learning apparatus 100 of FIG. 3, respectively.

The machine learning apparatus 200 of the embodiment differs from the related-art machine learning apparatus 100 in that the linguistic feature amount output part 210, the image feature amount output part 220, and the base class image selection part 230 are included in addition to the features of the related-art machine learning apparatus 100.

The linguistic feature amount output part 210 receives an input of the text describing the base class image, extracts a linguistic feature amount from the text describing the base class image by using a trained model trained on images and texts describing the images, and supplies the linguistic feature amount to the base class image selection part 230. The linguistic feature amount output part 210 corresponds to the text encoder 310 in FIG. 5 by way of example.

The image feature amount output part 220 receives an input of all base class images, extracts the image feature amount of each base class image by using a trained model trained on images and texts describing the images, and supplies the image feature amount of each image to the base class image selection part 230. The image feature amount output part 220 corresponds to the image encoder 300 of FIG. 5 by way of example.

The base class image selection part 230 receives the linguistic feature amount, the image feature amount of each image, and all base class images, selects a base class image having an image feature amount within a distance equal to or smaller than a predetermined threshold value from the linguistic feature amount as rehearsal data, and supplies the selected base class image to the NN lower layer part 110s.

The NN lower layer part 110s receives an input of the novel class image and an input of the base class image selected as the rehearsal data and outputs the value by using the weight θs in response to the base class image and the novel class image. The NN lower layer part 110s supplies the output based on the base class image and the output based on the novel class image to the base class classification output part 121 and supplies the output based on the novel class image to the novel class classification output part 122.

The base class classification output part 121 receives, as inputs, the output based on the base class image and the output based on the novel class image from the NN lower layer part 110s, outputs the base class classification by using the weight θo, and supplies the base class classification to the first loss calculation part 130s.

The novel class classification output part 122 receives, as an input, the output based on the novel class image from the NN lower layer part 110s, outputs a novel class classification by using the weight θn, and supplies the novel class classification to the first loss calculation part 130s.

The first loss calculation part 130s receives, as inputs, the base class classification and the novel class classification, calculates a knowledge distillation loss based on the base class classification, calculates a cross-entropy loss based on the novel class classification, and supplies the knowledge distillation loss and the cross-entropy loss to the first updating part 140s.

The first updating part 140s updates the weights θs, θo, and θn to reduce a sum of the knowledge distillation loss and the cross-entropy loss.

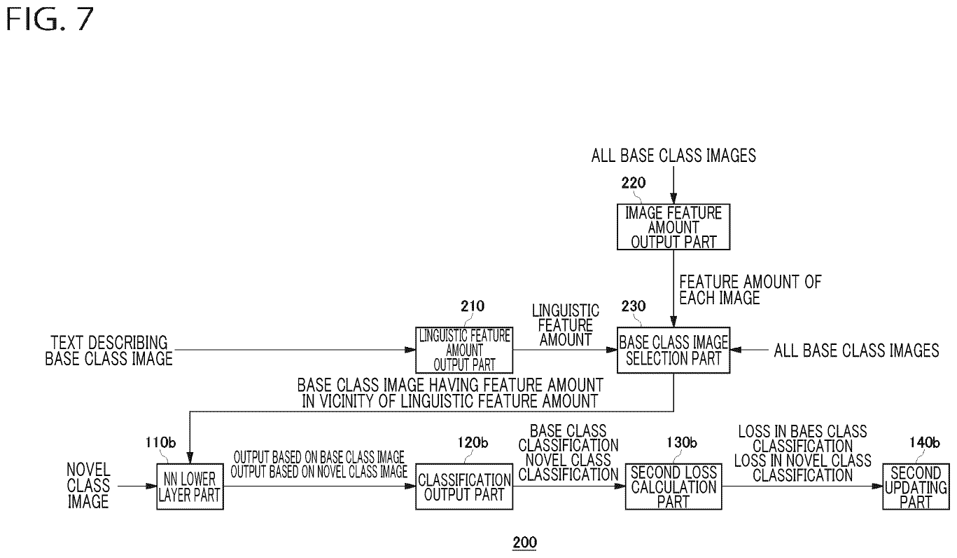

FIG. 7 shows a functional configuration of the machine learning apparatus 200 of the embodiment in the bridge phase. The machine learning apparatus 200 of the embodiment includes an NN lower layer part 110b, a classification output part 120b, a second loss calculation part 130b, a second updating part 140b, a linguistic feature amount output part 210, an image feature amount output part 220, and a base class image selection part 230.

The NN lower layer part 110b, the classification output part 120b, the second loss calculation part 130b, and the second updating part 140b of the machine learning apparatus 200 of FIG. 7 of the embodiment correspond to the NN lower layer part 110b, the NN upper layer part 120b, the second loss calculation part 130b, and the second updating part 140b of the related-art machine learning apparatus 100 of FIG. 4, respectively.

The operation of the linguistic feature amount output part 210, the image feature amount output part 220, and the base class image selection part 230 is the same as that of the split phase of FIG. 6 so that a description thereof is omitted.

The NN lower layer part 110b receives an input of the novel class image and an input of the base class image selected as the rehearsal data and outputs the value by using the weight θs in response to the base class image and the novel class image. The NN lower layer part 110b supplies an output based on the base class image and an output based on the novel class image to the classification output part 120b.

The classification output part 120b receives, as inputs, outputs the output based on the base class image and the output based on the novel class image from the NN lower layer part 110b and outputs the base class classification and the novel class classification by using the weight θp integrating the weights θo and θn updated in the split phase, and supplies the base class classification and the novel class classification to the second loss calculation part 130b.

The second loss calculation part 130b calculates the knowledge distillation loss and the cross-entropy loss based on the integrated classification that integrates the outputs of the base class classification and the novel class classification and supplies the knowledge distillation loss and the cross-entropy loss to the second updating part 140b.

The second updating part 140b updates the weights θs and θp to reduce a sum of the knowledge distillation loss and the cross-entropy loss.

According to the machine learning apparatus 200 of the embodiment, effective class incremental learning is enabled by generating a linguistic feature including a visual notion of the base class and selecting an image having a feature in the vicinity of the linguistic feature as an image (rehearsal data) for the base class.

The above-described various processes in the machine learning apparatus 200 can of course be implemented by apparatuses that use hardware such as a CPU and a memory and can also be implemented by firmware stored in a ROM (read-only memory), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiments. The embodiments are intended to be illustrative only and it will be understood by those skilled in the art that various modifications to combinations of constituting elements and processes are possible and that such modifications are also within the scope of the present disclosure.

What is claimed is:

1. A machine learning apparatus comprising:
a linguistic feature amount output part that receives a text describing a base class image and outputs a linguistic feature amount;
an image feature amount output part that receives the base class image and outputs an image feature amount;
a base class image selection part that receives the linguistic feature amount, the image feature amount, and the base class image and selects a base class image corresponding to the image feature amount having a distance equal to or smaller than a predetermined threshold value from the linguistic feature amount; and
a pre-trained neural network, including:
a neural network lower layer part that receives the base class image selected by the base class image selection part and a novel class image and outputs a value; and
a neural network upper layer part that is provided on an output side with respect to the neural network lower layer part and that includes: a base class classification output part that receives an output value of the neural network lower layer part based on the base class image and the novel class image and that outputs a base class classification which is a classification based on the base class image and the novel class image; and a novel class classification output part that receives an output value of the neural network lower layer part based on the novel class image and that outputs a novel class classification which is a classification based on the novel class image,
the machine learning apparatus further comprising:
a loss calculation part that calculates a loss in the base class classification and a loss in the novel class classification based on the base class classification and the novel class classification; and
an updating part that updates a weight of the neural network lower layer part, a weight of the base class classification output part, and a weight of the novel class classification output part based on a sum of the loss in the base class classification and the loss in the novel class classification.

2. The machine learning apparatus according to claim 1,
wherein the linguistic feature amount output part and the image feature amount output part are respectively pre-trained on an input of the base class image and the text describing the base class image.

3. A machine learning method comprising:
receiving a text describing a base class image and outputting a linguistic feature amount;
receiving the base class image and outputting an image feature amount;
receiving the linguistic feature amount, the image feature amount, and the base class image and selecting a base class image corresponding to the image feature amount having a distance equal to or smaller than a predetermined threshold value from the linguistic feature amount;
receiving, in a neural network lower layer part of a pre-trained neural network, i) the base class image selected by the selecting of a base class image and ii) a novel class image and outputting a value;
in a neural network upper layer part that is provided on an output side with respect to the neural network lower layer part, i) by a base class classification output part, receiving an output value of the neural network lower layer part based on the base class image and the novel class image and outputting a base class classification which is a classification based on the base class image and the novel class image and ii) by a novel class classification output part, receiving an output value of the neural network lower layer part based on the novel class image and outputting a novel class classification which is a classification based on the novel class image;
calculating a loss in the base class classification and a loss in the novel class classification based on the base class classification and the novel class classification; and
updating a weight of the neural network lower layer part, a weight of the base class classification output part, and a weight of the novel class classification output part based on a sum of the loss in the base class classification and the loss in the novel class classification.

4. A computer-readable non-transitory recording medium storing a machine learning program comprising computer-implemented modules including:
a module that receives a text describing a base class image and outputs a linguistic feature amount;
a module that receives the base class image and outputs an image feature amount;
a module that receives the linguistic feature amount, the image feature amount, and the base class image and selects a base class image corresponding to the image feature amount having a distance equal to or smaller than a predetermined threshold value from the linguistic feature amount; and
a module that receives, in a neural network lower layer part of a pre-trained neural network, i) the base class image selected by the module that selects a base class image and ii) a novel class image and outputting a value;
a module that, in a neural network upper layer part that is provided on an output side with respect to the neural network lower layer part, i) by a base class classification output part, receives an output value of the neural network lower layer part based on the base class image and the novel class image and outputs a base class classification which is a classification based on the base class image and the novel class image and ii) by a novel class classification output part, receives an output value of the neural network lower layer part based on the novel class image and outputs a novel class classification which is a classification based on the novel class image;
a module that calculates a loss in the base class classification and a loss in the novel class classification based on the base class classification and the novel class classification; and
a module that updates a weight of the neural network lower layer part, a weight of the base class classification output part, and a weight of the novel class classification output part based on a sum of the loss in the base class classification and the loss in the novel class classification.
